(19) United States
(12) Patent Application Publication
(10) Pub. No.: US 2007/0122782 A1
(43) Pub. Date: May 31, 2007

(54) Interactive system and method of Christian devotion

(76) Inventor: Ramona M. Corwin, Plano, TX (US)

Correspondence Address: MICHAEL L. DIAZ, P.C., 555 REPUBLIC DRIVE, SUITE 200, PIANO, TX, 75074, US

(21) Appl. No.: 11/271,220

(22) Filed: Nov. 12, 2005

(51) Int. Cl. G09B 19/00

(52) U.S. Cl. 434/245

(57) ABSTRACT

The present invention is a system and method providing interactive instructional devotion for children during a religious holiday, such as Christmas. The system includes a Christmas tree with a plurality of bags positioned around the Christmas tree. Each bag contains a textual message card, an associated object, and an ornament. The textual message card provides a query or riddle and a referenced Bible passage providing an answer to the query or riddle. The object also provides a hint at the answer to the query. The ornament may be hung on the Christmas tree. A specific bag is opened each day and the query and Bible passage are discussed. The present invention may also be used for any religious holiday, such as Easter.

### FIELD OF THE INVENTION

This invention relates to Christian devotion. Specifically, the present invention relates to an interactive system and method of Christian devotion for children.

### DESCRIPTION OF THE RELATED ART

Daily meditation and education upon the Bible and its teachings. is well known throughout the world. To benefit from the teachings and revelations of the Bible, constant study and meditation is necessary. It is also quite important among Christians that young children take part in learning from the Bible and the Christian beliefs at an early age. However, it oftentimes is difficult to maintain the interest of children on any subject, including religion. Although children have a far greater capacity to learn than adults, their minds tend to frequently wander from the lesson at hand.

The Christmas season holds significant meaning to most Christians. In particular, the days leading up to Christmas, also known as the Advent season, provide many lessons for Christians to reflect and meditate upon. Additionally, there are many symbols holding multiple meaning on the teachings of Jesus. Currently, although these symbols may hold religious meanings, in today's secular society, the religious meanings are overshadowed by the commercialism prevalent in our society. For example, although Christmas involves the celebration of the birth of Jesus, in reality, many people equate the giving or receiving of gifts as the meaning of Christmas. Thus, it is quite easy for children to be confused by what is the true meaning of Christmas. A system and method are needed which can provide an interactive devotion and instruction on various teachings on Jesus which is directed to a particular religious season or occasion.

Thus, it would be a distinct advantage to have a system and method which instructs children in the teachings of Jesus while holding the interest of the children. In particular, it would be advantageous to have a system and method for use during particular seasonal events, such as Christmas and Easter. It is an object of the present invention to provide such a system and method.

### SUMMARY OF THE INVENTION

In one aspect, the present invention is a system providing an interactive devotional during a religious season. The system includes a centerpiece providing a symbolic representation of the religious season. A plurality of containers is positioned around the centerpiece. Each container includes an interior section having a textual message card and an object. The textual message card has a message providing a query and a referenced passage in a Bible associated with the query. The object provides an association with the query. A person opens one container each day, reads the message on the textual message card, observes the object and reads the referenced passage in a Bible.

In another aspect, the present invention is a method of providing an interactive instructional devotional for children during a religious season. The method begins by providing a textual message and an object in each container. The textual message provides a message having a query and a referenced Bible passage associated with the query. The object provides an association with the query. A plurality of containers is positioned near a centerpiece providing a symbolic meaning of the religious season. A specific container is selected daily. The selected container is opened and the contents are removed from the container. The message is read, the object is observed, and the Bible passage is referenced in a Bible.

In still another aspect, the present invention is a system providing an interactive devotional for children during the Christmas season. The system includes a Christmas tree centerpiece providing a symbolic representation of the Christmas season. A plurality of bags having an interior section is positioned around the Christmas tree. Each interior section has a textual message card, an object, and an ornament. The textual message card has a message providing a query and a referenced passage in a Bible associated with the query. The object provides an association with the query and a hint at an answer to the query. A child opens one bag daily, reads the message on the textual message card, observes the object, reads the referenced passage in a Bible, and positions the ornament on the Christmas tree centerpiece.

### BRIEF DESCRIPTION OF THE DRAWINGS

FIG. 1 is a simplified block diagram illustrating the components of a system providing interactive devotion and instruction on the teachings of the Bible in the preferred embodiment of the present invention;

FIG. 2 provides a front perspective view of the system of FIG. 1; and

FIGS. 3A-3C are flow charts outlining the steps for providing an interactive devotional for children according to the teachings of the present invention.

### DESCRIPTION OF THE INVENTION

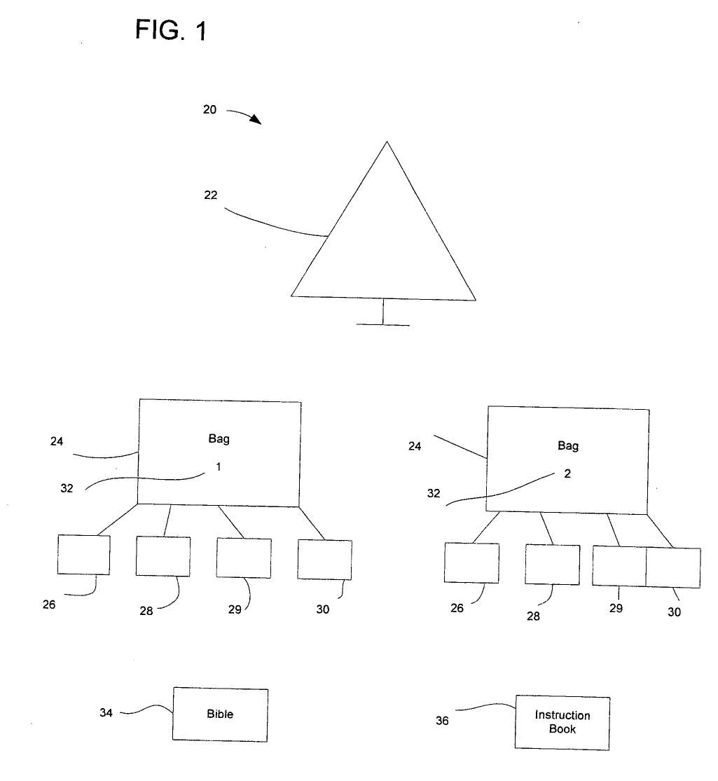

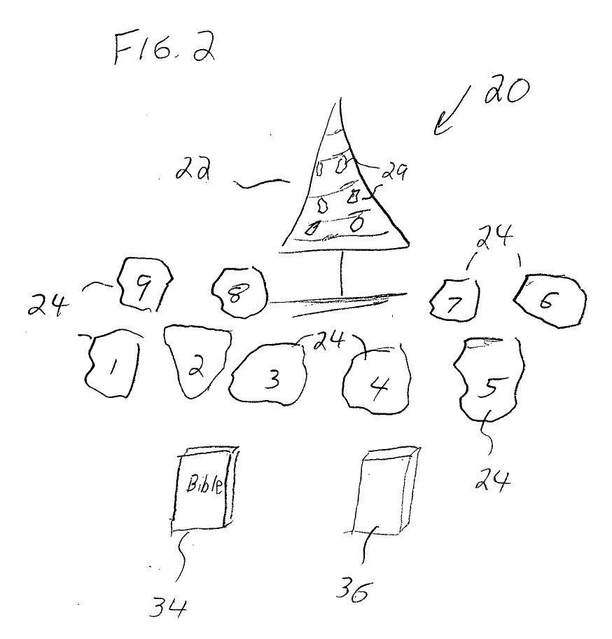

The present invention is a system and method providing interactive devotional and instruction on the teachings of the Bible for children. FIG. 1 is a simplified block diagram illustrating the components of a system 20 providing interactive devotion and instruction on the teachings of the Bible in the preferred embodiment of the present invention. FIG. 2 provides a front perspective view of the system 20 of FIG. 1. The system is illustrated and explained for use during the Advent season proceeding the Christmas holiday. But it should be understood, that the same principles may be employed during other seasons holding religious significance, such as the Easter season. During the Advent season, the days leading up to Christmas and the celebration of the birth of Jesus are noted by Christians. The system includes a centerpiece (Christmas tree) 22 and a plurality of bags 24. Each bag 24 contains a textual message card 26, an object 28, an optional ornament 29, and an optional treat 30. Each bag also includes an identification reference 32 located on an exterior surface of the bag. The system also includes a Bible 34 and may include a devotional instruction book 36.

In the preferred embodiment of the present invention, the identification reference 32 is positioned on an exterior surface of each bag. In the preferred embodiment of the present invention, the identification reference equates to a specific day before Christmas. Thus, there would be 25 bags corresponding to the days of the month of December prior to and on Christmas. However, in alternate embodiments of the present invention, the identification reference 32 may be any symbol used to identify the days of the season holding a special significance to Christians. For example, during the Easter season, the forty days prior to Easter may be used to provide identification to 40 bags representing the days prior to Easter. The bags may be any container sufficiently big to hold and hide various objects in an interior portion of the container. In the preferred embodiment of the present invention, the bags are constructed of a textile material (e.g., velvet), which obscures the contents of the bag.

Within each bag 24 is a textual message card 26. The textual message card includes a query or riddle and a reference to the Bible for the answer to the query. Additionally, the card may be associated with the object 28 enclosed with the same bag. For example, the object may include a water globe showing a snowman on top of snow. The card may state “This snowman looks like he is walking on water . . . Read Matthew 14:22-23. . . to see someone else who walked on water.” Thus, the textual message card references the object 28 and includes a referenced passage in the Bible 34 which assists in answering the present query or riddle.

Each bag may also optionally include an ornament 29 and a treat 30. The ornament may or may not be associated with the textual message card 26. The ornament preferably is sized and shaped to fit upon the centerpiece Christmas tree 22. In the preferred embodiment of the present invention, the ornament is hung on the Christmas tree 22. The treat may be a toy or candy which is desired by a child.

The Bible 34 is preferably a version of the Bible which is easily readable or understood by the age group of children utilizing the system 20. In addition, the system 20 may include a devotional instruction book 36 which may include detailed lesson plans or discussions on the lessons learned on specific days.

With reference to FIGS. 1-2, the operation of the system 20 will now be explained. First, the centerpiece Christmas tree 22 is preferably placed in the center of the system 20. To provide a reminder of the meaning of the entire devotional, a Christmas nativity scene may be optionally positioned in front of the Christmas tree 22. A plurality of bags 24 are positioned around the Christmas tree 22. Each bag includes an exterior identification reference 32 identifying the day prior to Christmas. For example, December 1 would have a “1” exterior marking, December 2 would have a “2” marking, etc.

Within each bag is a textual message card 26, an object 28, an optional ornament 29 and an optional treat 30. The textual message card includes a riddle or query associated with a specific passage in the Bible 34. The object is associated with the riddle to provide a hint at the answer. The textual message card will also include a reference passage in the Bible which holds the answer to the riddle.

Each day, a child selects the appropriate bag for that day. The child opens the bag and removes the contents of the selected bag. The child reads the riddle on the textual message card 26 and observes the object 28. The child may meditate on the answer prior to referencing the Bible. As desired, the child then seeks and finds the referenced passage in the Bible 34 listed on the textual message card. The child reads the referenced passage.

Preferably, an adult is present during this procedure. The adult may optionally reference the devotional instruction book 36. For each day during the Advent season, the instruction book provides additional information, such as guidelines on discussions and object lessons which may be discussed to reinforce the meaning of each day's topic.

After reading the referenced passage, the child may optionally position the object 28 on the Christmas tree 22. Additionally, the child may optionally enjoy the treat 30. If there are several children involved in the process, the tasks may optionally be divided to ensure that all the children become involved in the process. For example, one child may read the riddle on the textual message card 26, one child may place the ornament 29 on the Christmas tree 22, and one child may look up and read the answer in the Bible 34.

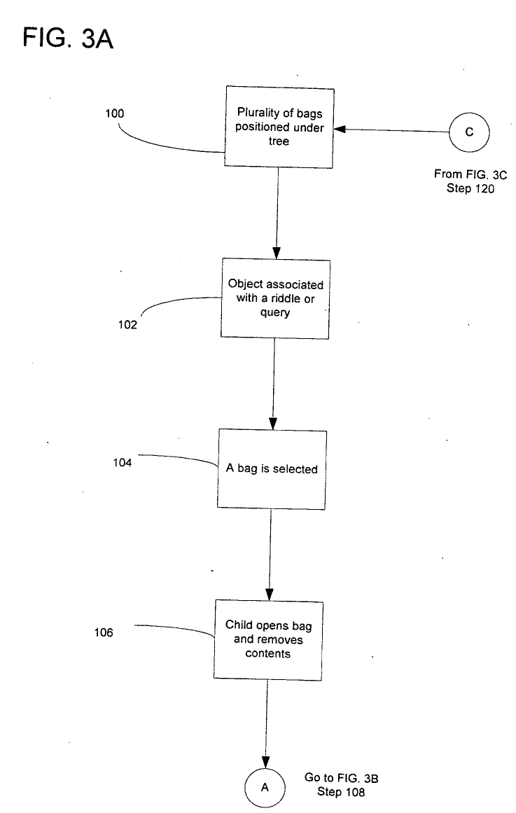

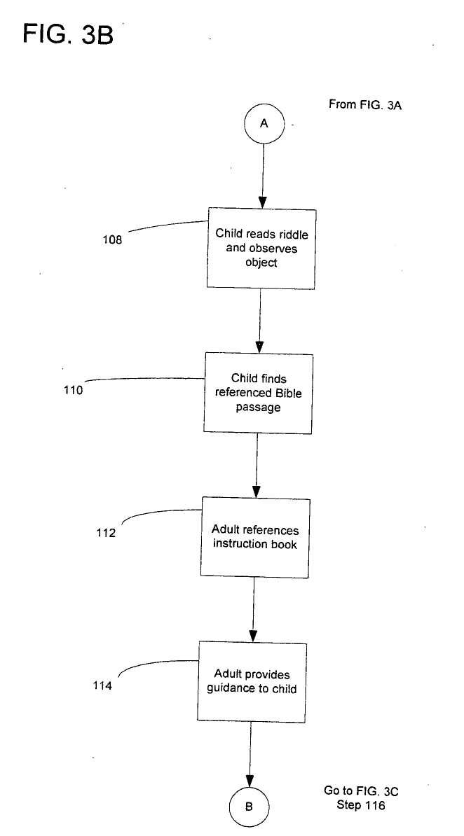

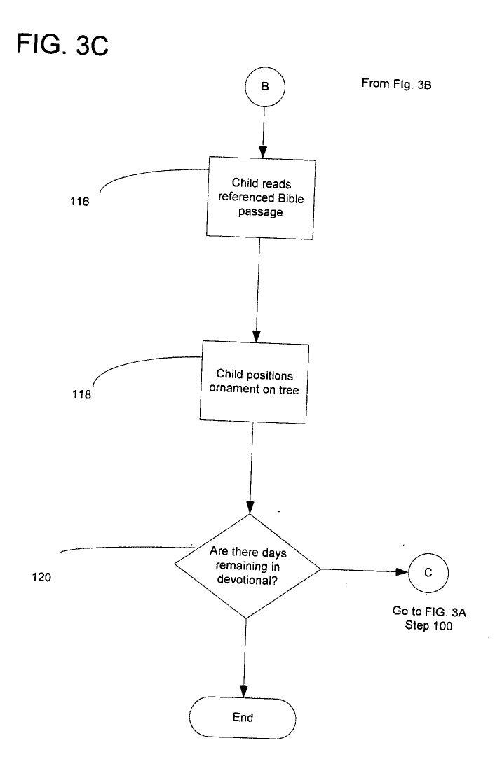

FIGS. 3A-3C are flow charts outlining the steps for providing an interactive devotional for children according to the teachings of the present invention. With reference to FIGS. 1-3, the steps of the method will now be explained. The method begins with step 100 where a plurality of bags is positioned under the Christmas tree 22. Within each bag is a textual message card 26, and object 28, an optional ornament 29 and an optional treat 30. The textual message card includes a riddle or query associated with a specific passage in the Bible 34. In step 102, each object is associated with the riddle provided in the textual message card. The object also provides a hint at the answer to the riddle. The textual message card will also include a reference passage in the Bible which holds the answer to the riddle.

The method then moves to step 104, where each day, a child selects the appropriate bag for that day. In step 106, the child opens the bag and removes the contents of the selected bag. Next, in step 108, the child reads the riddle on the textual message card 26 and observes the object 28. The child may meditate on the answer prior to referencing the Bible. As desired, the child moves to step 110, where the child seeks and finds the referenced passage in the Bible 34 listed on the textual message card.

The method then optional moves to step 112 where an adult present during the method references the devotional instruction book 36. The instruction book may provide additional information relevant to the topic presented on the textual message card 26 and referenced passage in the Bible 34. In step 114, the adult may provide additional guidance on the subject matter to the child or children present during the method.

Next, in step 116, the child reads the referenced passage in the Bible 34. After reading the referenced passage, the method may optionally move to step 118 where the child positions the ornament 29 on the Christmas tree 22. Additionally, the child may optionally enjoy the treat 30. If there are several children involved in the process, the tasks may optionally be divided to ensure that all the children become involved in the process. For example, one child may read the riddle on the textual message card 26, one child may place the ornament 29 on the Christmas tree 22, and one child may look up and read the answer in the Bible 34. In step 120, it is determined if there are days remaining during the devotion. If it is determined that there are days remaining, the method moves to step 100 where steps are repeated the next day. The method is used for each day prior to or on a religious holiday (e.g., Christmas). If it is determined that there are no days (or bags remaining), the method stops at step 120.

The present invention may be utilized in various seasons of the religious calendar year. For example, the same methodology and system may be implemented during the Easter season whereby a plurality of bags is opened for each day prior to Easter. There may be 40 bags, each providing a special message for each day leading up to Easter. It should be understood that the present invention may be utilized with a plurality of bags which may be opened during any time period (e.g., hourly, weekly, monthly, etc.).

The present invention provides many advantages over existing methodologies and systems relating to religious education. The present invention enables a child to participate in a manner which holds his interest in the entire subject matter while allowing the child to retain information learned for each day. The object reinforces the learning process by providing a visual symbol for which it allows the child to associate the referenced passage in the Bible. By requiring the child to look up the referenced passage in the Bible, the child becomes more familiar with the contents and format of the Bible. This may encourage the child to read other passages in the Bible with comfort.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system providing an interactive devotional during a religious season, the system comprising:
a centerpiece providing a symbolic representation of the religious season;
a plurality of containers having an interior section, each interior section having a textual message card and an object;
the textual message card having a message providing a query and a referenced passage in a Bible associated with the query;
the object providing an association with the query;
whereby a person opens one container each desired time period, reads the message on the textual message card, observes the object and reads the referenced passage in a Bible.

2. The system providing an interactive devotional of claim 1 wherein the religious season is Christmas.

3. The system providing an interactive devotional of claim 2 wherein the centerpiece is a Christmas tree.

4. The system providing an interactive devotional of claim 3 further comprising an ornament stored in each container, whereby the container is opened, the ornament is positioned on the Christmas tree.

5. The system providing an interactive devotional of claim 1 wherein the containers are bags.

6. The system providing an interactive devotional of claim 5 wherein the bags are constructed of a material preventing the viewing of the contents of the bag.

7. The system providing an interactive devotional of claim 1 wherein the desired time period is daily.

8. The system providing an interactive devotional of claim 1 wherein each container has an exterior identification identifying when to open each container.

9. The system providing an interactive devotional of claim 1 wherein the devotional is for a child.

10. The system providing an interactive devotional of claim 9 wherein each container includes a treat for the child opening the container.

11. The system providing an interactive devotional of claim 1 further comprising a devotional instructional book providing supplemental instruction on each referenced Bible passage.

12. The system providing an interactive devotional of claim 1 wherein each object associated with the textual message card provides a hint at an answer to the query.

13. The system providing an interactive devotional of claim 1 wherein the religious season is Easter.

14. The system providing an interactive devotional of claim 1 wherein each query is a riddle which is answered in the referenced Bible passage.

15. A method of providing an interactive instructional devotional for children during a religious season, the method comprising the steps of:
providing a textual message and an object in each container, the textual message providing a message having a query and a referenced Bible passage associated with the query, the object providing an association with the query;
positioning a plurality of containers near a centerpiece providing a symbolic meaning of the religious season;
selecting a specific container each desired time period;
opening the selected container and removing the contents of the container;
reading the message;
observing the object; and
referencing the Bible passage in a Bible.

16. The method of providing an interactive instruction devotional of claim 15 wherein the religious season is Christmas and the centerpiece is a Christmas tree.

17. The method of providing an interactive instruction devotional of claim 16 wherein each container includes an ornament and further includes the step of positioning the ornament on the Christmas tree.

18. The method of providing an interactive instruction devotional of claim 15 wherein each query is a riddle which is answered in the referenced Bible passage.

19. A system providing an interactive devotional for children during the Christmas season, the system comprising:
a Christmas tree centerpiece providing a symbolic representation of the Christmas season;
a plurality of bags having an interior section, each interior section having a textual message card, an object, and an ornament;
the textual message card having a message providing a query and a referenced passage in a Bible associated with the query;
the object providing an association with the query and a hint at an answer to the query;
whereby a child opens one bag daily, reads the message on the textual message card, observes the object, reads the referenced passage in a Bible, and positions the ornament on the Christmas tree centerpiece.
